(19) United States
(12) Patent Application Publication
(10) Pub. No.: US 2010/0199569 A1
(43) Pub. Date: Aug. 12, 2010

(54) Oversized, stress-transferring spacer for window assembly, and window assembly incorporating the same

(76) Inventor: Daniel Piedade, Barrington, RI (US)

Correspondence Address: NIXON & VANDERHYE, PC, 901 NORTH GLEBE ROAD, 11TH FLOOR, ARLINGTON, VA, 22203, US

(21) Appl. No.: 12/591,512

(22) Filed: Nov. 20, 2009

Related U.S. Application Data
(60) Provisional application No. 61/202,220, filed on Feb. 6, 2009.

(51) Int. Cl. E05B 1/00; E06B 7/00

(52) U.S. Cl. 49/460; 49/70

(57) ABSTRACT

Certain example embodiments relate to window assemblies that include hardware components that reduce stress loads applied to the transparent substrates in such window assemblies. In certain example embodiments, a spacer (e.g., which may be formed from a metal such as, for example, stainless steel or aluminum) that is longer than the window thickness is provided so that loads applied to the other hardware components are transferred along the spacer and so that a reduced load is applied to the substrate itself. Such assemblies are useful in a wide variety of applications including, for example, the transportation industry.

### CROSS-REFERENCE TO RELATED APPLICATION

This application claims the benefit of U.S. Application Ser. No. 61/202,220, the entire contents of which are hereby incorporated herein by reference.

### FIELD OF THE INVENTION

Certain example embodiments of this invention relate to window assemblies. More particularly, certain example embodiments of this invention relate to window assemblies that include hardware components that reduce stress loads applied to the transparent substrates in such window assemblies. In certain example embodiments, a spacer (e.g., a stainless steel or aluminum spacer) that is longer than the window thickness is provided so that loads applied to the other hardware components are transferred along the spacer and so that a reduced load is applied to the substrate itself. Such assemblies are useful in a wide variety of applications including, for example, the transportation industry.

### BACKGROUND AND SUMMARY OF EXAMPLE EMBODIMENTS OF THE INVENTION

Window assemblies for the transportation industry are known. For example, window assemblies have been provided for trains, busses, and the like, and include various pieces of hardware such as, for example, handle bars, sills, rails, etc., may be attached to a glass substrate. Such window assemblies typically require a significant amount of structural integrity to pass all of the regulations required for such applications. Indeed, such window assemblies typically require a significant amount of structural integrity so that they survive the assembly process and the sometimes stringent requirements associated with frequent use in connection with a potentially high-use system.

FIG. 1 is an example cross-sectional view of a conventional window assembly suitable for the transportation industry. Currently, hardware for use in connection with window assemblies suitable for the transportation industry is supplied with a rubber spacer/washer 3. The rubber spacer/washer 3 is sized so as to correspond with the thickness T of the glass substrate 1 and any lamination layer 2 applied thereto. The rubber spacer 3 holds the main hardware element in place with respect to the glass substrate 1 and the lamination layer 2, e.g., by being inserted into a hole H cut in the glass substrate 1 and the lamination layer 2. In the example shown in FIG. 1, the main hardware element is attached to the glass substrate 1 and the lamination layer 2 using a screw 7 and a first washer 11 interposed between the screw 7 and the first surface of the substrate 1, and a bolt 5 and a second washer 9 interposed between the bolt 5 and the second surface of the substrate 1.

Although this conventional arrangement works well on most products that are not brittle in nature, it does not work well on glass. Indeed, the manufacturing of window assemblies for the transportation industry is plagued with many internal rejects. Even when properly assembled, such window assemblies are susceptible to significant failures and in some cases require premium materials in order for them to work reliably within their respective applications. Failures during manufacturing and/or use include, for example, breakage of the window assembly, including separation of some or all of the hardware from the glass substrate, shattering of the glass, removal of a laminated layer often applied over the glass, etc.

FIG. 2 shows an example of the type of failure that may occur during manufacturing and/or use of a conventional window assembly for the transportation industry. In the FIG. 2 example, the main hardware element comprises a handle bar assembly 15. The glass substrate 1 has been at least partially shattered, and the lamination layer 2 has been pulled back from the shattered area as well as other areas of the substrate 1. Such failures result in reductions in yield during manufacturing and potential safety concerns during both manufacturing and commercial use. The reduction in yield also typically results in longer lead-times being required for manufacturing. All of these problems increase costs, and sometimes even require the use of special, higher-grade components.

Thus, it will be appreciated that there is a need in the art for improved techniques for providing assemblies to windows, e.g., for use in the transportation industry. For example, it will be appreciated that there is a need in the art for improved assemblies that are capable of withstanding increased pressure loads and/or forces. Advantageously, such improved assemblies will result in higher manufacturing yields (e.g., by reducing conventional losses) and also improve overall safety, while reducing the need for special, higher-grade components.

One aspect of certain example embodiments relates to including a slightly oversized sleeve or spacer (e.g., a metal spacer made of, for example, stainless steel or aluminum) in place of the conventional rubber spacer in window assemblies, which surprisingly and unexpectedly causes pressures exerted on the units to be transmitted along the spacers of certain example embodiments, thus reducing the likelihood of overall unit failure.

In certain example embodiments of this invention, a window assembly is provided. A substrate has at least one hole formed therethrough for facilitating connection with a hardware component. The hardware component comprises a main body, and at least one spacer having a length greater than a thickness of the substrate. The spacer is located in the at least one hole of the substrate such that a portion of the spacer at least initially protrudes beyond each surface of the substrate.

In certain example embodiments of this invention, a hardware component for a window assembly comprising a substrate is provided. A main body is provided, which ultimately will be used as a handle bar. First and second spacers are provided, with each being sized so as to have a length greater than a thickness of the substrate such that portions of the first and second spacers, when respectively located in first and second holes formed in the substrate, at least initially protrude beyond each surface of the substrate.

According to certain example embodiments, first and second elongate screw members may be provided, with the screw members extending through the first and second spacers, and first and second bolts may removably connect the screw members of the main body to the substrate. According to certain example embodiments, washers may be provided on opposing ends of each spacer, with each washer optionally having a rubber face oriented towards the spacer.

In certain example embodiments of this invention, a window assembly for a commercial transportation vehicle is provided. A substrate has first and second holes formed therethrough for facilitating connection with a hardware component. The hardware component comprises a main body, with the main body being a handle bar. First and second spacers each are sized so as to have a length greater than a thickness of the substrate such that portions of the first and second spacers, when respectively located in the first and second holes formed in the substrate, at least initially protrude beyond each surface of the substrate. First and second elongate screw members are provided at opposing ends of and generally perpendicular to the main body, with the screw members extending through the first and second spacers. First and second bolts removably connect the screw members of the main body to the substrate.

The features, aspects, advantages, and example embodiments described herein may be combined to realize yet further embodiments.

### BRIEF DESCRIPTION OF THE DRAWINGS

These and other features and advantages will be better and more completely understood by reference to the following detailed description of exemplary illustrative embodiments in conjunction with the drawings, of which:

FIG. 1 is an example cross-sectional view of a conventional window assembly suitable for the transportation industry;

FIG. 2 shows an example of the type of failure that may occur during manufacturing and/or use of a conventional window assembly for the transportation industry;

FIG. 3 is an example cross-sectional view of an improved window assembly incorporating a spacer in accordance with an example embodiment; and

FIGS. 4a and 4b respectively show example first and second side views of the hardware components of a window assembly ready to be attached to a glass substrate, in accordance with an example embodiment.

### DETAILED DESCRIPTION OF EXAMPLE EMBODIMENTS OF THE INVENTION

Certain example embodiments of this invention include a slightly oversized sleeve or spacer (e.g., a metal spacer made of, for example, stainless steel or aluminum) in place of the conventional rubber spacer in window assemblies. The spacer of certain example embodiments surprisingly and unexpectedly causes pressures exerted on the units to be transmitted along the spacers, thus reducing the likelihood of overall unit fracture. In other words, changing the spacer material to a metal such as, for example, stainless steel or aluminum, and oversizing the spacer advantageously allows the pressures that are exerted on the glass/material to be transmitted from the top of the hardware down to the other constraining (e.g., nut and washer) assembly. The design of certain example embodiments can be made in various thicknesses and also can allow for or less hardware slop that is conventional, or even none at all. The amount of slop allowed may be determined as a factor of thickness, e.g., of the glass substrate.

With the current rubber spacer design, when hardware is applied to the laminated glass assembly, very little force will crack the unit. This is because the conventional rubber spacer does nothing but center the handle hardware. In marked contrast, the new design performs a structural function, e.g., by reducing the amount of force that holds the handle hardware to the glass substrate that ultimately is transferred to the glass. Furthermore, the spacer of certain example embodiments allows only a certain amount of force to be applied to the glass, while most (if not all) of the remaining force passes through the spacer.

Thus, the spacer design of certain example embodiments allows the hardware to be tightened down during manufacturing while reducing the amount of force applied to the glass because it will reduce the amount of the tightening force being applied the glass once any rubber layer on the washers are exceeded. In some example cases, some over-tightening also may be permitted.

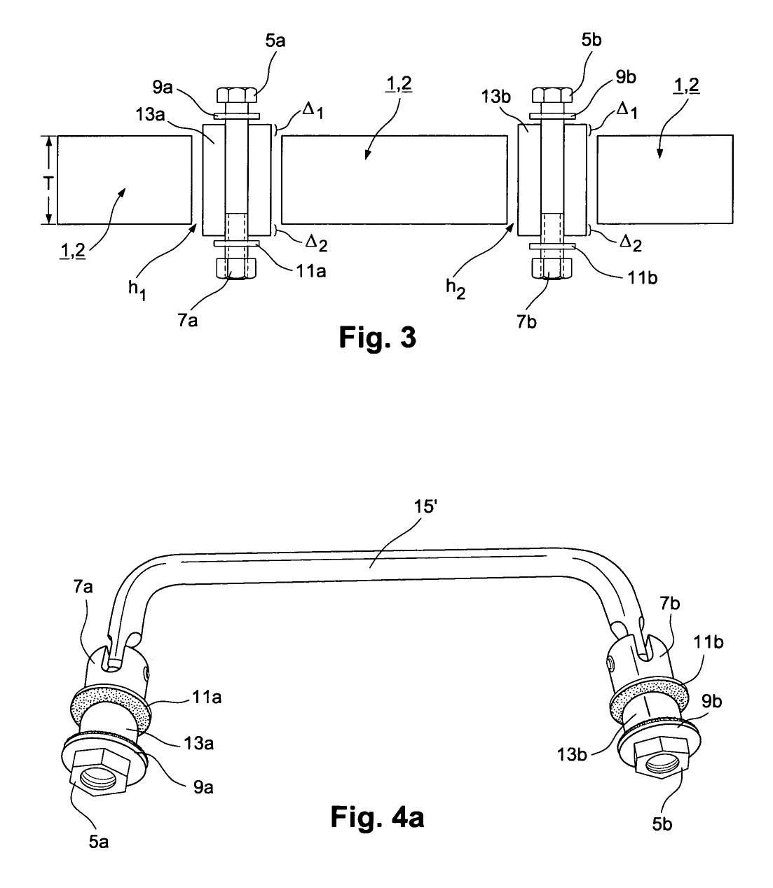

It will be appreciated that the oversizing of the spacer in certain example embodiments is described in relation to the laminated glass sheet. The amount of oversizing may change in dependence on the thickness of the laminated window, the type of hardware being connected to the glass substrate, etc. In this regard, FIG. 3 is an example cross-sectional view of an improved window assembly incorporating a spacer in accordance with an example embodiment.

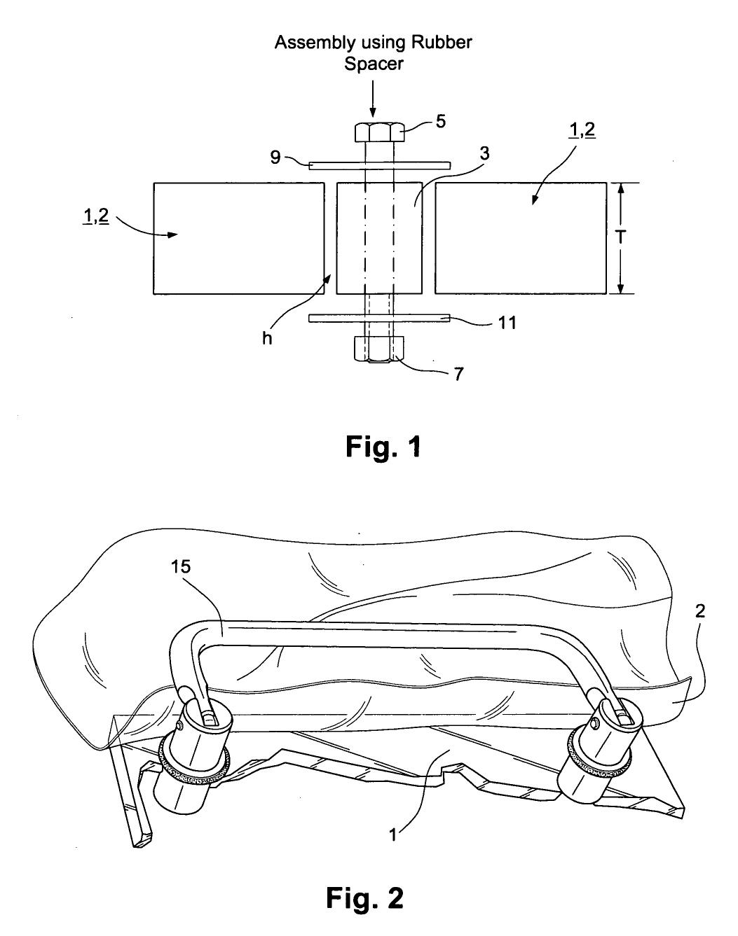

FIG. 3 is similar to FIG. 1 in that it shows first and second spacers 13a and 13b located in first and second holes h₁ and h₂ formed in the glass substrate having a lamination layer 2 applied thereto. Thus, like the FIG. 1 arrangement, the spacers 13a and 13b hold the main hardware elements in place with respect to the glass substrate 1 and the lamination layer 2, e.g., by being inserted into the first and second holes h₁ and h₂ cut in the glass substrate 1 and the lamination layer 2. Furthermore, similar to the FIG. 1 arrangement, the main hardware elements are attached to the glass substrate 1 and the lamination layer 2 using first and second screws 7a and 7b and first and second washers 11a and 11b, respectively interposed between the first and second screws 7a and 7b and the first surface of the substrate 1. Similarly, first and second bolts 5a and 5b and third and fourth washers 9a and 9b are respectively interposed between the first and second bolts 5a and 5b and the second surface of the substrate 1.

However, unlike the FIG. 1 arrangement, the spacers 13a and 13b of certain example embodiments are slightly longer than the thickness of the laminated glass, so that the process of bolting the handle to the glass does not significantly squeeze the glass or transfer pressure loads to the glass. In other words, each of the first and second spacers 13a and 13b shown in FIG. 3 have a length greater than the thickness T of the of the laminated glass substrate. In the FIG. 3 example embodiment, the first and second spacers 13a and 13b have a length greater than the thickness T of the of the laminated glass substrate so that they extend somewhat beyond the first and second surfaces of the laminated glass substrate. These protrusions beyond the first and second surfaces of the laminated glass substrate are shown as Δ₁ and Δ₂ in FIG. 3. Of course, it will be appreciated that Δ₁ and Δ₂ may be the same or different amounts. In fact, the actual amounts Δ₁ and Δ₂ may vary slightly from the desired amounts once the window assembly manufacturing is complete, as some over- or under-tightening of the hardware may occur, hardware assembly might shift back and forth slightly once assembled, etc.

In certain example embodiments, the amount of Δ₁ and Δ₂, when summed or individually, may be about 0.050″. In other words, the spacers 13a and 13b may be oversized compared to the thickness T of the laminated glass substrate in certain example embodiments, with the oversizing corresponding to a total protrusion, from both surfaces of the laminated glass substrate, either individually or together, by about 0.050″. Of course, it will be appreciated that other oversizing amounts may be used in connection with certain example embodiments.

In embodiments where stainless steel or aluminum spacers are used, it will be appreciated that the wall thickness of the spacers should be sufficient so as to a suitably rigid structure to avoid a situation in which the spacer collapses under pressure. The inventor has discovered that a wall thickness of about 1-2 mm is sufficient when stainless steel or aluminum spacers are used, although thickness can be increased from this range in applications, for example, where a small profile is not necessary, where it is aesthetically pleasing to provide a larger spacer, etc. Although certain example embodiments have been described as including metal spacers (e.g., stainless steel or aluminum spacers in certain example embodiments), other suitably rigid materials may be used. Wall thickness of the spacer in such embodiments may vary based on, for example, the rigidity of the material. Thus, a wall thickness of greater than 1-2 mm in embodiments where the spacer material is less rigid and/or structurally sound than that of stainless steel or aluminum.

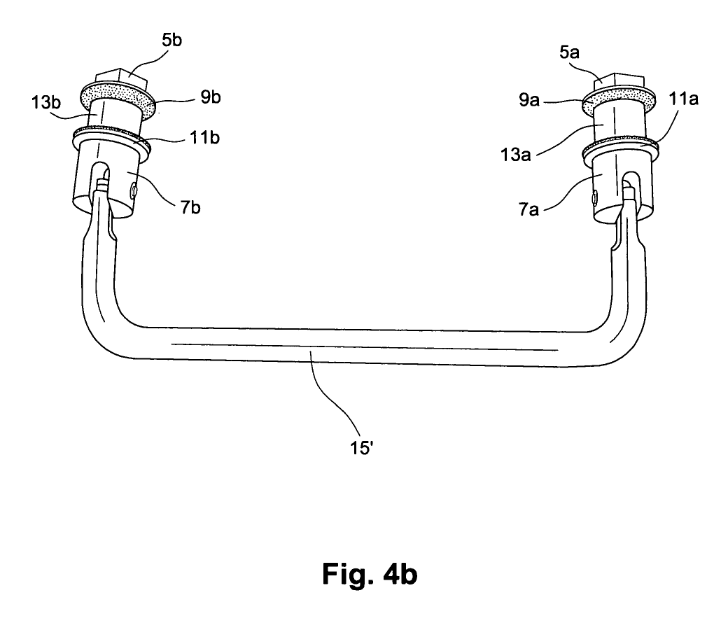

FIGS. 4a and 4b respectively show example first and second side views of the hardware components of a window assembly ready to be attached to a glass substrate, in accordance with an example embodiment. More particularly, FIGS. 4a and 4b show an improved hardware element that comprises an improved handle bar assembly 15′. The handle bar assembly 15′ incorporates the hardware arrangements shown schematically in FIG. 3, including the first and second spacers 13a and 13b that are oversized with respect to any laminated glass substrate to which the hardware element shown in FIGS. 4a and 4b is to be attached. The improved hardware element shown in FIGS. 4a and 4b is similar to that shown in FIG. 2, with the exception of the first and second spacers 13a and 13b being provided in FIGS. 4a and 4b. As will be described below, the improved hardware element shown in FIGS. 4a and 4b, which incorporates the first and second spacers 13a and 13b, surprisingly and unexpectedly resulted in superior results, at least in terms of the stress and force loads that is was able to accommodate.

Initial testing of these samples proved to be very positive, as each sample successfully accommodated significant loads being placed on each handle. This is a superior result compared to the conventional design, which sometimes suffers from glass fracture following the application of levels of pressure that merely correspond to hand-tightening. These superior levels of performance allow manufacturers to reduce their dependence on custom, high-end components. For example, manufacturers can use regular laminated glass products in certain example instances as opposed to chemically treated laminated glass products, thus making the assemblies considerably less costly to produce. Optionally, the washers of certain example embodiments may be rubber coated on an underside thereof, so as to protect the glass and provide at least some slip protection.

It will be appreciated that differently shaped, sized, or otherwise formed hardware elements/components may be provided in certain example embodiments. For example, although certain example embodiments have been described in connection with a substantially linear handle bar (for example, as shown in FIGS. 4a and 4b), differently shaped handle bars also may be provided. For example, substantially circular, ovular, triangular, hook-shaped, and/or other handle bars may be provided in certain example embodiments. Other hardware components/elements, such as rails, etc., also may be provided. These alternate hardware components/elements may be connected to the glass substrate through one, two, three, or any combination of holes. In addition, the example spacers described herein may be used in connection with other fastening means such as, for example, glues, adhesives, and/or the like.

Although certain example embodiments have been described as including glass substrates, it will be appreciated that different example embodiments may use other transparent or substantially transparent sheets. For example, substrates of or including plastics, composite materials, and/or the like may be used in connection with certain example embodiments. Furthermore, although certain example embodiments have been described in connection with laminated glass substrates, certain example embodiments may not necessarily include lamination layers. In embodiments where lamination layers are applied, such lamination layers may be formed by any suitable means such as, for example, spraying, dipping, spin or roll coating, sputtering, combustion deposition, pyrolytic techniques, etc. In general, the lamination layers may be chemically formed or mechanically applied (e.g., from a pre-formed sheet).

Although certain example embodiments have been described in connection with transportation industry applications (e.g., windows, doors, etc., provided for trains, busses, and/or the like), it will be appreciated that the techniques described herein can be applied to a wide variety of applications. For example, the techniques described herein can be applied to any assembly that involves hardware being connected to a potentially fragile substrate. This may include, for example, bathroom applications (shower doors, mirrors, etc.), commercial and non-commercial vehicles (sliders for pickups, tractors, or the like), etc.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A window assembly, comprising:
a substrate having at least one hole formed therethrough for facilitating connection with a hardware component,
wherein the hardware component comprises:
a main body, and
at least one spacer having a length greater than a thickness of the substrate, the spacer being located in the at least one hole of the substrate such that a portion of the spacer at least initially protrudes beyond each surface of the substrate.

2. The window assembly of claim 1, wherein the spacer is made of metal.

3. The window assembly of claim 2, wherein the spacer comprises aluminum.

4. The window assembly of claim 2, wherein the spacer comprises stainless steel.

5. The window assembly of claim 1, wherein the spacer has a wall thickness of 1-2 mm.

6. The window assembly of claim 1, wherein:
the substrate comprises first and second holes formed therethrough for facilitating connection with the hardware component,
the main body of the hardware component is a handle bar,
the hardware component comprises first and second spacers, each having a length greater than a thickness of the substrate, the first and second spacers being located in the first and second holes of the substrate such that portions of each spacer at least initially protrude beyond each surface of the substrate.

7. The window assembly of claim 6, wherein the main body of the hardware component comprises two elongate screw members, the screw members extending through the first and second spacers and being removably connected to the substrate via first and second bolts.

8. The window assembly of claim 7, further comprising washers provided on opposing ends of each spacer.

9. A hardware component for a window assembly comprising a substrate, the hardware component comprising:
a main body, the main body being a handle bar;
first and second spacers, each being sized so as to have a length greater than a thickness of the substrate such that portions of the first and second spacers, when respectively located in first and second holes formed in the substrate, at least initially protrude beyond each surface of the substrate.

10. The hardware component of claim 9, further comprising:
first and second elongate screw members, the screw members extending through the first and second spacers; and
first and second bolts for removably connecting the screw members of the main body to the substrate.

11. The hardware component of claim 10, further comprising washers provided on opposing ends of each spacer.

12. The hardware component of claim 11, wherein each said washer includes a rubber face oriented towards the spacer.

13. The hardware component of claim 9, wherein the spacer comprises aluminum.

14. The hardware component of claim 9, wherein the spacer comprises stainless steel.

15. The hardware component of claim 9, wherein the spacer has a wall thickness of 1-2 mm.

16. A window assembly for a commercial transportation vehicle, comprising:
a substrate having first and second holes formed therethrough for facilitating connection with a hardware component,
wherein the hardware component comprises:
a main body, the main body being a handle bar,
first and second spacers, each being sized so as to have a length greater than a thickness of the substrate such that portions of the first and second spacers, when respectively located in the first and second holes formed in the substrate, at least initially protrude beyond each surface of the substrate,
first and second elongate screw members provided at opposing ends of and generally perpendicular to the main body, the screw members extending through the first and second spacers, and
first and second bolts for removably connecting the screw members of the main body to the substrate.

17. The window assembly of claim 16, further comprising washers provided on opposing ends of each spacer.

18. The window assembly of claim 17, wherein each said washer includes a rubber face oriented towards the spacer.

19. The window assembly of claim 16, wherein the spacer comprises aluminum or stainless steel.

20. The window assembly of claim 16, wherein the spacer has a wall thickness of 1-2 mm.
